(19) United States
(12) Patent Application Publication
(10) Pub. No.: US 2003/0098869 A1
(43) Pub. Date: May 29, 2003

(54) Real time interactive video system

(76) Inventors: Glenn Christopher Arnold, Knoxville, TN (US); Thach Cam Le, Irvine, CA (US); Ann Marie Kaesman, Los Angeles, CA (US); Daniel Louis Bates, Manhattan Beach, CA (US); Jorge Geaga, Los Angeles, CA (US)

Correspondence Address: KATTEN MUCHIN ZAVIS, Attention: Patent Administrator, Suite 1600, 525 West Monroe Street, Chicago, IL, 60661-3693, US

(21) Appl. No.: 10/039,924

(22) Filed: Nov. 9, 2001

(51) Int. Cl. G09G 5/02

(52) U.S. Cl. 345/589

(57) ABSTRACT

A real time interactive video system for use in real time broadcasts as well as video on demand systems which requires no modification of a television set. In a real time broadcast application, the video content is broadcast for playback on a conventional television or monitor. Frames are extracted from the video content in predetermined time intervals, such as one second intervals, and stored in a directory on an Internet server. For example, for a 30 frame per second video source, one frame of every 30 is extracted and stored as a still image along with linked video files which link pixel objects with the stored frames to data objects, or other resource platforms. In order to synchronize the stored frames and linked video files with the real time video content broadcast, each frame is either numbered sequentially, or referenced by the time code of the frame from which it was extracted. Interactivity with the real time video content broadcast in real time is provided by way of a viewer interaction platform, for example, a computing platform, such as a personal computer or a set top box, or a wireless platform, such as personal digital assistant (PDA) or cell phone, such as a 3G cell phone, linked to the Internet server which hosts the stored frames and linked video files. In accordance with an important aspect of the invention, a video frame interaction application, resident on the view interaction platform, allows a viewer to select specific frames from the video content, as it is broadcast and stores these frames in the memory of the viewer interaction platform. If the viewer interaction platform has limited memory, an Internet link to the image can be saved. The frames are chosen by activating an “entry key” on the view interaction platform. The user selection is either sent to the website for immediate retrieval of the selected frame, or alternatively, the requested linked is saved for later access to the website. The website, upon request, sends the selected frame to the video frame interaction application which allows the viewer to access pixel objects and link to other resource platforms.

### CROSS-REFERENCE TO RELATED APPLICATIONS

This application is related to commonly-owned copending patent application Ser. No. 09/679,391, filed Oct. 3, 2000, entitled “Method and Apparatus for Associating the Color of an Object with an Event.” This application is also related to commonly-owned co-pending patent application Ser. No. 09/679,391, filed on Aug. 31, 2001, entitled “System and Method for Tracking an Object in a Video and Linking Information Thereto.”

### Computer Listing Appendix

This application includes a Computer Listing Appendix on compact disc, hereby incorporated by reference.

### BACKGROUND OF THE INVENTION

1. Field of the Invention

The present invention relates to a real time interactive video system which enables individual frames appearing in a sequence of video frames broadcast in real time to be selected and stored for on demand access. Accessible within these frames are video or pixel objects that are linked to data objects on other resource platforms.

2. Description of the Prior Art

Various interactive video systems are known which allow viewer interaction with video content by way of various transport media, such as coaxial cable and telephone wire. For example, various video on demand (VOD) systems are known which allow a user to select video content, such as movies, special event broadcasts and the like for playback. Examples of such video on demand systems are disclosed in U.S. Pat. Nos. 5,752,160; 5,822,530; 6,184,878; and 6,204,843. In such video on demand systems, the user interface typically includes a set top box connected to transport media to provide a bi-directional communication link between the user and the video content provider. More specifically, video content selections are transmitted to the video content provider, such as a broadcast or cable TV provider. User content selections are processed by a so-called head-end processor, which processes the user's request and causes the selected video content to be transmitted to the user's set top box for playback on a monitor or a television.

Such video on demand systems are not real time systems. In particular, the video content in such video on demand systems is normally prerecorded and stored in a suitable storage media, such as a video content server, for transmission on demand. In such video on demand systems, the user controls the playback time of the selected video. More specifically, the playback time is determined by the time a request for the video content is made by the user.

Other systems are known which provide interactivity with video content on a real time basis. Such systems are generally known as multicasting systems. Examples of such multicasting systems are disclosed in U.S. Pat. Nos. 5,724,691; 5,778,187; 5,983,005 and 6,252,586. Such multicasting systems relate to video content distribution systems which simultaneously deliver multiple channels of video content in real time and enable user to select the content but not the time for receiving the selected video content.

Systems which provide interactive messaging along with video content are also known. For example, U.S. Pat. Nos. 5,874,985; 5,900,905 and 6,005,602 disclose video messaging systems which overlay video content with programming or emergency messages. In such systems, the messages are continuously displayed until actively acknowledged by an end user.

Other interactive video systems are known which link static objects in the video content with other resource platforms. Examples of such systems are disclosed in U.S. Pat. Nos. 5,781,228; 5,907,323; and 6,240,555. In particular, the '228 patent discloses an interactive video system in which static icons are displayed adjacent the video content. The static icons are linked to informational resources, such as audio, video or animated content.

U.S. Pat. No. 5,907,323 discloses an interactive television program guide. This interactive system includes a display window adjacent the program guide which can provide additional information on selected programs when selected.

U.S. Pat. No. 6,240,555 discloses an interactive video system which provides static links to other resource platforms. In particular, an interactive panel is displayed adjacent the playback window. The interactive panel includes various buttons including educational and merchandising buttons that are linked to other resource platforms. Selection of one of the buttons links the viewer to a collection of information related to the video content. For example, selection of the merchandising button displays a number of merchandising items related to the video content that are available for sale.

U.S. Pat. Nos. 5,903,816; 5,929,850; and 6,275,989 disclose interactive television systems which include one or more broadcast channels and an on demand viewer selection channel. The on demand viewer selection channel includes static images related to the video content in the broadcast channels. The viewer may select one of the static images for display or link to other static images.

All of the systems described above relate to interactive video systems which provide interactivity with static pixel objects related to the video content. In order to improve the entertainment level of such interactive video systems, systems have been developed which provide interactivity with dynamic pixel objects within the video content itself. Examples of such systems are disclosed in U.S. Pat. Nos. 6,205,231 and 5,684,715. These patents relate to interactive television systems in which tags are embedded in the video content. In particular, tags are embedded for various pixel objects within the video content to enable a pixel object to be selected. Unfortunately, such systems are only suitable for on-demand content. Such systems have heretofore not been known to be suitable for real time broadcast.

Other systems have been developed to provide interactivity in connection with real time broadcasts. An example of such a system is disclosed in U.S. Pat. No. 6,253,238. This system provides interactive pseudo-web pages which can be selected to obtain various types of information, generally unrelated to the video content, such as e-mail messages, sport scores, weather and the like. Unfortunately, such systems do not provide interactivity with the digital content on a real time basis. Thus, there is need for an interactive video system which provides interactivity with the digital content on a real time basis.

### SUMMARY OF THE INVENTION

Briefly, the present invention relates to real time interactive video system for use in real time broadcasts as well as video on demand systems which requires no modification of a television set. In a real time broadcast application, the video content is broadcast for playback on a conventional television or monitor. Frames are extracted from the video content in predetermined time intervals, such as one second intervals, and stored in a directory on an Internet server. For example, for a 30 frame per second video source, one frame of every 30 is extracted and stored as a still image along with linked video files which link pixel objects with the stored frames to data objects, or other resource platforms. In order to synchronize the stored frames and linked video files with the real time video content broadcast, each frame is either numbered sequentially, or referenced by the time code of the frame from which it was extracted. Interactivity with the real time video content broadcast in real time is provided by way of a viewer interaction platform, for example, a computing platform, such as a personal computer or a set top box, or a wireless platform, such as personal digital assistant (PDA) or cell phone, such as a 3G cell phone, linked to the Internet server which hosts the stored frames and linked video files. In accordance with an important aspect of the invention, a video frame interaction application, resident on the view interaction platform, allows a viewer to select specific frames from the video content, as it is broadcast and stores these frames in the memory of the viewer interaction platform. If the viewer interaction platform has limited memory, an Internet link to the image can be saved. The frames are chosen by activating an “entry key” on the view interaction platform. The user selection is either sent to the website for immediate retrieval of the selected frame, or alternatively, the requested linked is saved for later access to the website. The website, upon request, sends the selected frame to the video frame interaction application which allows the viewer to access pixel objects and link to other resource platforms.

### DESCRIPTION OF THE DRAWINGS

These and other advantages of the present invention will be readily understood with reference to the following specification and attached drawing wherein:

FIG. 1A is a block diagram of the real time interactive video system in accordance with the present invention.

FIG. 1B is an exemplary graphical user interface for use with the real time interactive video system illustrated in FIG. 1A.

FIG. 2 is a software flow diagram of the frame capture and export application in accordance with the present invention.

FIG. 3 is a block diagram of an exemplary frame buffer for use with the present invention.

FIGS. 4A and 4B are software flow diagrams of the navigational control buttons for use with the present invention.

FIG. 5 is a block diagram of a system for generating linked video files for use with the present invention.

FIG. 6 is a screen shot of a developmental graphical user interface for use in a developing the linked video files.

FIG. 7 is a system level software diagram of the system illustrated in FIG. 5.

FIG. 8 is a software flow diagram of the system illustrated in FIG. 5, illustrating a frame extraction application.

FIGS. 9A and 9B are flow diagrams of the pixel object capture portion of the system illustrated in FIG. 5.

FIG. 10 is a flow diagram of the automatic tracking portion of the system illustrated in FIG. 3.

FIG. 11 illustrates the automatic tracking of an exemplary red frame against a blue background for two successive frames for the system illustrated in FIG. 10.

### DETAILED DESCRIPTION

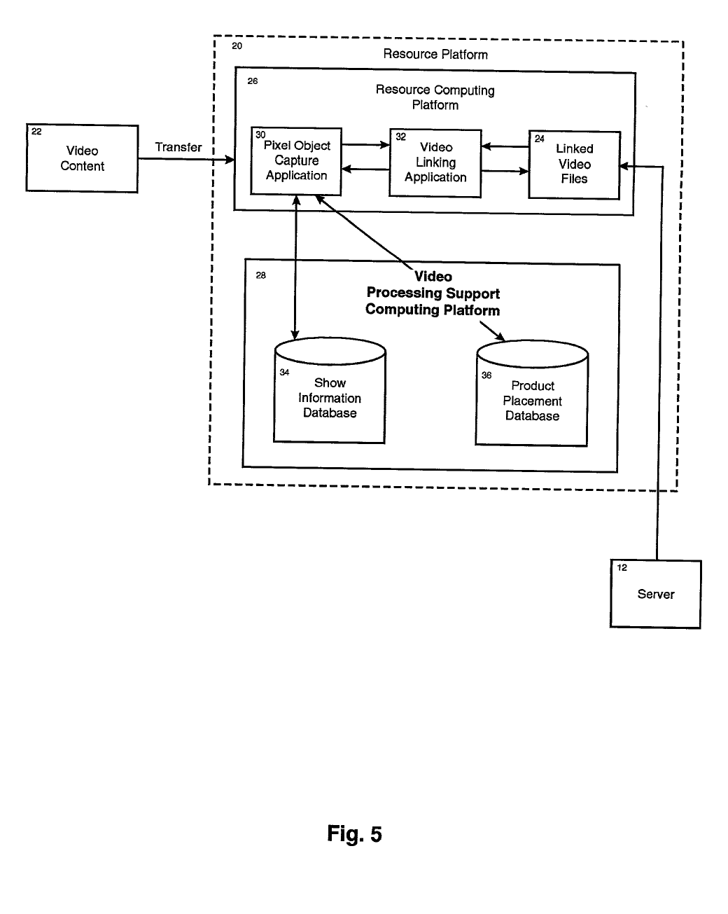

The present invention relates to a real time interactive video system for use with both real time and video on demand content. In accordance with an important aspect of the invention, the video content is preprocessed, for example, by a video content provider, or application service provider, by a method which creates linked data files that identify interactive pixel objects within the content by frame number and the x, y coordinates of each object. The creation of the linked video files is described in detail in connection with FIGS. 5-11. In general, the linked data files also include data object files which link the various pixel objects to a uniform resource locator, fixed overlay information, a streaming video link, a database interaction link or other resource platform hereinafter “data object”. As will be discussed in more detail below, the use of linked data files avoids the need to embed tags in the original video content. However, the principles of the present invention are also applicable to video content with embedded tags, embedded either by manual or automatic authoring image processing systems, such as disclosed, for example, in U.S. Pat. No. 6,205,231, hereby incorporated by reference.

Video Content File Storage

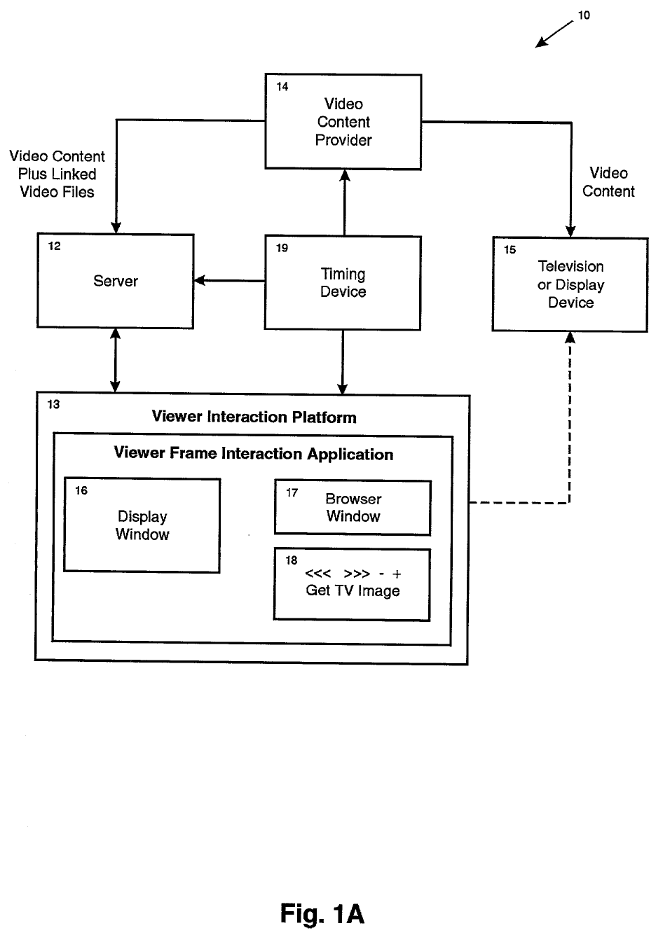

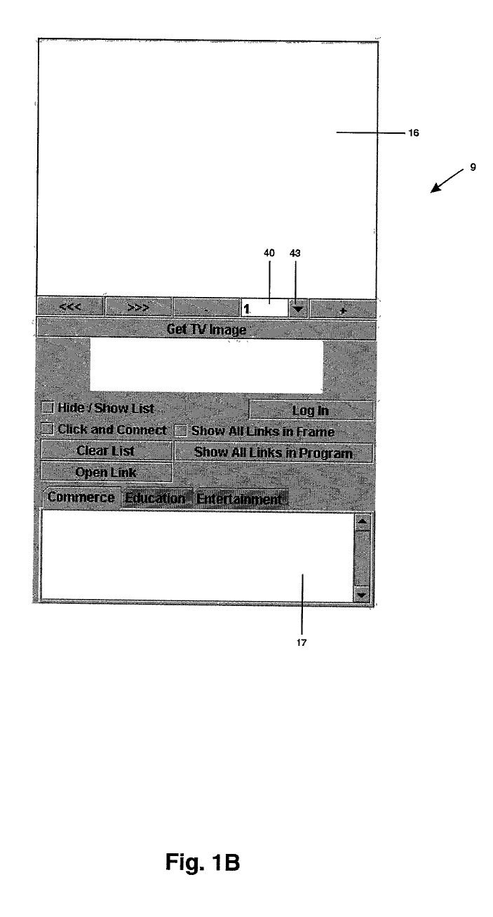

In addition to preprocessing of the video content as discussed above, the video content is partitioned into predetermined time segments, for example, one second segments, hereinafter “frames”. These frames are converted to a small image file type, such as a .jpeg, .tif or .gif file. Each of the image files, which represent a frame, is sequentially numbered and stored in a directory hosted by a server 12 (FIG. 1), such as a web server. In particular, the first frame of video content is identified as one; the second one second section as two, etc. As will be discussed in more detail below, such a file structure for storage of the video content facilitates synchronization of the real time broadcast with playback of the video content on a video playback platform 13 to provide interactivity with the video content on a real time basis.

Alternately the images which represent the video content frames may be identified by the time code number taken from the video frame from which it was created, and stored in a directory hosted by a server. In this method synchronization between broadcast programming and the linked data files is provided by analysis of the time code numbers.

In accordance with an important aspect of the invention, broadcast of the video content by the video content provider is synchronized or near synchronized with the digital content exported from the server 12 to the video playback platform 13 by way of a timing device 19. As will be discussed in more detail below, such timing devices are normally used to generate timing signals that are transmitted by video content providers and distributors 14 to synchronize all of the broadcasts of the video content throughout the broadcast network. Leitch Technology Corporation is known to provide such timing signals for many known video content providers and distributors 14. An example of such a timing device, identified with the reference numeral 19, as provided by Leitch Technology Corporation, is disclosed in U.S. Pat. No. 6,191,821, hereby incorporated by reference. Such a system is known to be accurate to one second per year.

Alternately, the synchronization between the video images being broadcast and the images files being in a directory on a server may be maintained by a computer device created to accurately read time code information from an on-going broadcast and trigger computer commands based on information programmed into its memory based on the time code information of the program being broadcast. Mixed Signals, Inc. (http:/www.mixedsignals.com) is known to provide such monitoring technology.

In accordance with the present invention, the timing signals from the timing device 19 are also applied to the server 12 as well as to the viewer interaction platform 13. As such, the broadcast of the video content by the video content provider or distributor allows for interactivity with the digital content on a real time basis, as will be discussed in more detail below. Alternately, if a time code is being used as the method to provide synchronization, the timing device 19 sends a frame accurate time code signal to the server 12 hosting the content information. Thus, when a request is sent by the video frame interaction application to the server 12, the server 12 synchronizes the request to the incoming information regarding the frame being broadcast at that moment and sends the appropriate frame image.

Video Frame Interaction Application

As shown in FIG. 1A, a view interaction platform 13 is provided to enable a viewer to interact with video content on a real time basis with absolutely no modifications to the television or display device. The viewer interaction platform 13 may be a computing platform, such as a personal computer or a set top box, or a wireless platform, such as personal digital assistant (PDA) or a cell phone, such as 3G cell phone or other wireless devices. A viewer frame interaction application, resident on the viewer interaction platform, may be used to support a display window 16, a browser window 17 implemented, for example, as a graphical user interface, for example, as shown in FIG. 1B and a set of control buttons, collectively identified with the reference numeral 18, and displayed. In embodiments in which viewer interaction platform 13 does not include a display, such as a set top box embodiment, the display window 16 and browser window 17 and control buttons may be displayed on the television or display 15, for example, after the broadcast of the video content.

The images shown in the display window 16 are controlled by the control buttons 18. The display window 16 is for displaying the selected video frames while the browser window 17 may be used to display the information that resides in the linked video files, such as the data objects.

Interactive Real Time Video Playback

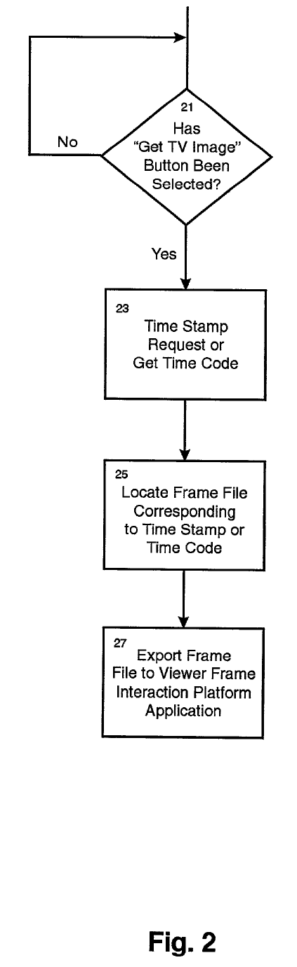

The frames of the video content are stored in a directory on the server 12 and synchronized in one of two ways with a broadcast program in order to provide interactivity with the video content on a real time basis. For example, frames are extracted from the video content in predetermined time intervals, such as one second intervals, and sequentially stored in a directory on the server 12. In the first embodiment, where synchronization is based on time, the system monitors the control buttons 18 (FIG. 1). Any time a “Get TV Image” control button 18 is selected, or button with a similar function, as indicated in step 21 (FIG. 2), the request is time stamped in step 23. The time stamp request is exported via the Internet to the server 12 which locates the frame file corresponding to the time stamp in step 25. In particular, a user request, for example at 8:08:05 p.m. would correspond to file number 485 (60 sec/min×8 min×1 file/sec+5 sec×1 file/sec) since, in this example, the video content is stored in the server 12 in one second segments. The frame file is exported to the video frame interaction application 13 in step 27

In the second embodiment, where a time code is used as a synchronization method, a computer, for example, located at the broadcast facility, monitors a video program as it airs. As the program airs, the time code information is sent to the server 12. When the “Get TV Image” or similar button is activated, a request for the frame being broadcast at that moment is immediately sent to the server 12. The server 12 synchronizes the request with the frame information being sent from the computer monitoring the broadcast. The server 12 processes the request and sends the video frame interaction application the frame closest in time to the one requested, since the frames are stored in one second intervals.

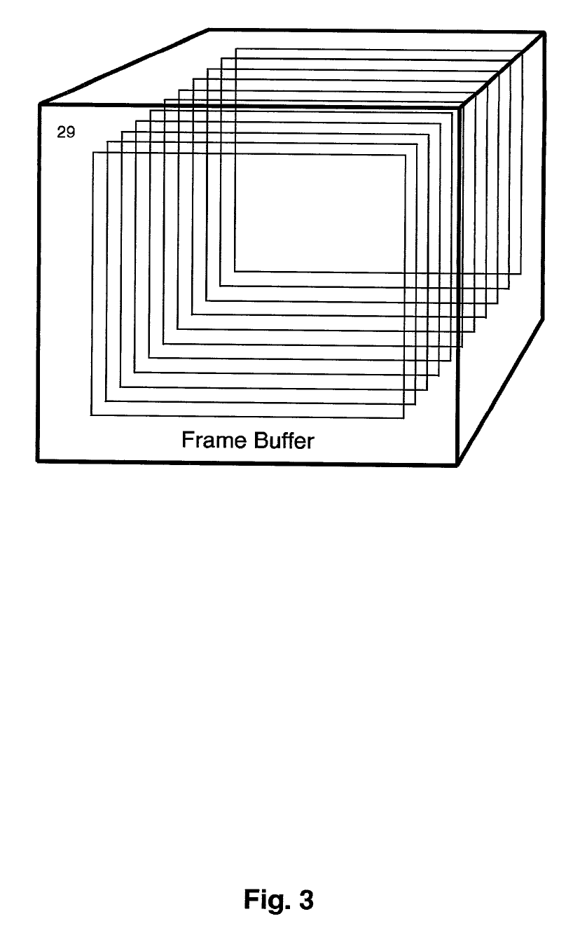

As shown in FIG. 3, all of the frames that correspond to time stamps or time codes may be stored in a frame buffer 29 located at the server 12 in sequential order along with the linked video files which link data objects with specific pixel objects in each of the frames. During the program, or at the end of the broadcast, the viewer then has the option of reviewing the frames in the frame buffer 29 for pixel objects of interest in those frames as discussed below.

In order to facilitate navigation of the frames, various frame navigational buttons are provided. For example, local frame advance navigation buttons may be provided. In particular, a <<< (back) button allows a viewer to page back through frames locally stored in the viewer interaction platform 13 on frame by frame basis. Server frame advance buttons may also be provided. These server frame advance buttons allow a user to page through unselected frames on the server 12 (FIG. 1). In particular, a (+) button allows a user to page forward through unselected frames in the server 12 on a frame by frame basis. A (−) button allows a user to page backward through unselected frames in the server 12 on a frame by frame basis.

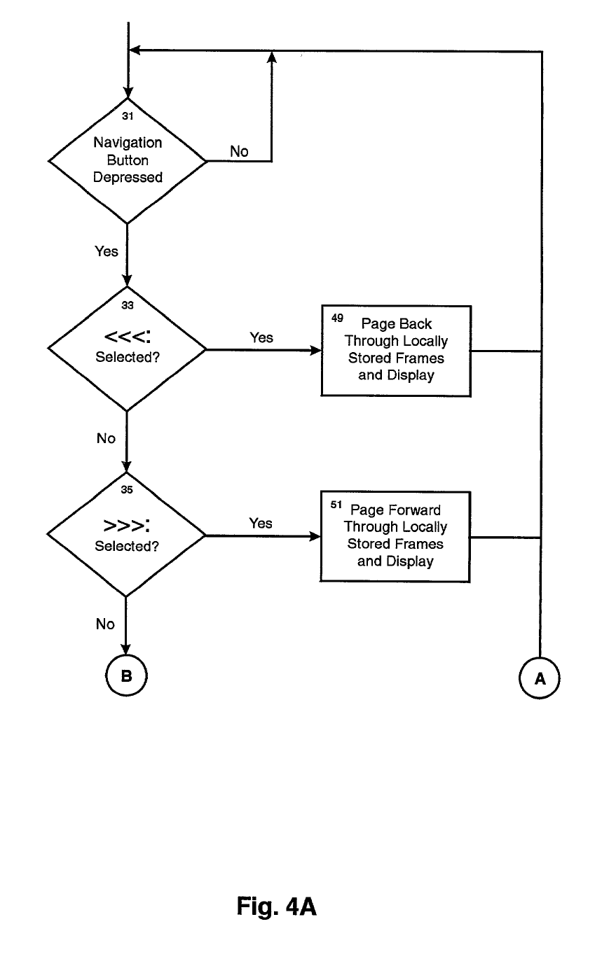

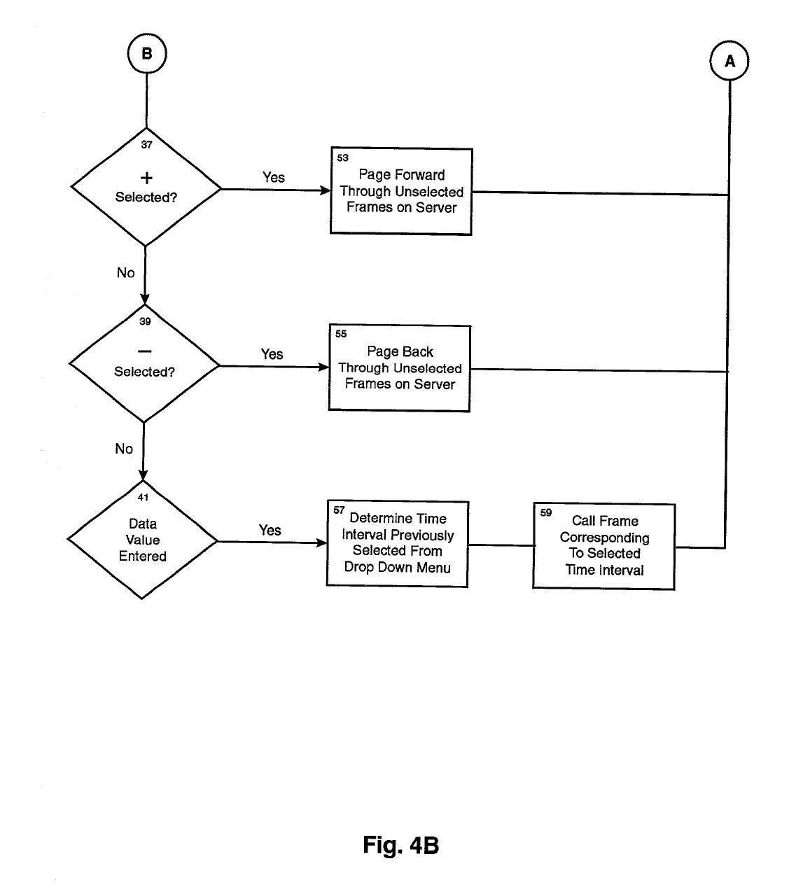

FIGS. 4A and 4B are flow charts for the navigational buttons. With reference first to FIG. 4A, the system monitors in step 31 whether any of the navigational buttons are depressed. If not, the system continues to monitor whether any of the navigational buttons are depressed. If one of the navigational buttons is depressed, the system checks in steps 33-39 (FIGS. 4A and 4B) to determine which navigational button was depressed or whether data has been entered into a frame advance dialog box 40 (FIG. 1B) in step 41.

If the system determines in steps 33 or 35 that one of the local frame advance navigational buttons, <<< or >>>, has been selected, the system pages either backward or forward, depending on the local frame advance navigational button selected, through frames locally stored in the viewer interaction platform 13 (FIG. 1) on a frame by frame basis and displays the selected frame in the display window 16 in steps 49 or 51, respectively. Similarly, if the system determines in steps 37 or 39 (FIG. 4B) that one of the server frame advance control buttons, (+) or (−), have been selected the system, in steps 53 or 55, pages either backward or forward, depending on the server frame advance navigational button selected, through unselected frames stored at the server 12 (FIG. 1) and displays the selected frame in the display window 16.

If the system determines that none of the frame advance navigational buttons have been selected, the system checks in step 41 (FIG. 4B) whether a data value has been entered into the frame advance dialog box 40 (FIG. 1B). The frame advance dialog box 40 allows unselected frames stored at the server 12 (FIG. 1A) to be called on a time interval basis. A drop down menu 43 (FIG. 1B) may be provided to provide a choice of time intervals, for example, seconds or minutes. After the system determines that a data value has been entered into the frame advance dialog box 40 (FIG. 1B), the system determines the previously selected time interval, for example, seconds or minutes, to determine the selected frame. For example, if the number 2 has been entered in the frame advance dialog box 40 and the “minutes” time interval was previously selected by way of the drop down menu 43, the system would call, for example, file number 120 (60 sec/min×2 minutes×1 file/sec) in step 59 and display the selected frame in the display window 16 (FIG. 1).

Interaction Video Graphical User Interface

Playback of the video content and linked video files 24 is by way of the viewer interaction platform 13 (FIG. 1). The viewer interaction platform 13 includes the viewer frame interaction application which supports a common media player API 40 for playback of the video content and provides resources for accessing the linked video files to enable pixel objects to be selected with a standard pointing device, such as a mouse, and linked to one or more data objects.

In particular, the viewer frame interaction application reads the linked data files discussed above and stores these files in two arrays. The first array may be single dimensional and may contain information about the video content and in particular the segments. The second array may be used to provide information regarding the location of the pixel objects of clickable areas for each movie segments. Exemplary code for storing the linked data files into a first array and a second array is provided in an Appendix.

The video frame interaction application enables pixel objects within the video content to be selected with a standard pointing device, such as a mouse. The (x, y) coordinates of the location selected by the pointing device for the selected frame number is captured and compared with information in the linked video files 24 to determine whether the selected location corresponds to a selected pixel object. In particular, the (x, y) coordinates and frame number are compared to a pixel object file (discussed below) to determine if the selected location in the display window 16 corresponds to a pixel object. More specifically, for the selected frame, all clickable areas in the frame are scanned to determine the clickable area or pixel object that contains the x, y coordinates associated with the mouse click. If so, the system displays the data object that has been linked to the pixel object by way of the link index in the object file in the browser window 17 to provide user interaction with the video content broadcast in real time or on demand. Exemplary code for returning a link index is provided in the Appendix.

The video frame interaction application 42 may also provide for additional capability. For example, the graphical user interface 20 may be provided with buttons for categorizing the various data objects that have been linked to the video content. As shown, in FIG. 1B, the graphical user interface 9 may include categorical buttons, such as the entertainment, commerce and education buttons to display the data objects in each of the exemplary categories. These category titles may be customized for each program, and are dynamically written to reflect the content of the program being shown. In this configuration, the data object files are configured with such categorical information. As such, when one of the categorical buttons is selected, all of the selected links in that category are retrieved from the linked video files and displayed in browser window 17.

The graphical user interface 9 may also include additional functionality, for example, as seen in FIG. 1B. In particular, “Show All Links in a Frame” and “Show All Links in Program” buttons may also be provided. The “Show All Links in Frame” button displays all links in a given frame in the display window when selected. This function allows a user to scroll through the access content, for example, by way of a scroll buttons to locate the scene or frame in which the desired item appears. Once the frame has been located, the user can click within the displayed frame and all of the available items contained within the display frame are sorted and displayed in the display window. The “Show All Links” button, when selected, displays all of the data object links to the video content. The data objects are displayed in the display window.

“Hide/Show List”, “Login”, “Clear List” and “Open Link” buttons may also be provided. The “Hide/Show List” button may be used to hide or show the functions of the graphical user interface 9. In particular, when the “Hide/Show List” button is selected, an on/off state is toggled and stored in memory.

The Login button may be used to prevent or limit access by the video from interaction platform. The login capability may be used to capture valuable data about the user's habit and requested information. In this application, a web server (not shown) may be used to host a database of user information and password information commonly known in the industry. When the Login button is selected, a request is sent from the viewer interaction platform 13 to a login web server for authentication. An authentication message is then returned to the viewer interaction platform 13 to enable playback of the linked video content.

The Clear List button may be provided to delete all of the data objects in the display window 16. When the Clear List button is selected, the viewer interaction platform deletes 13 all of the data objects in a temporary memory used for the display window 16. An Open Link button allows for additional information for selected data objects to be accessed. In particular, once a data object is selected from the display window, selection of the open link button may be used to provide any additional information available for the selected data object.

Video Content Pre-Processing

As mentioned above, the system in accordance with the present invention is suitable for use for both real time broadcast and video on demand video content. The video content is pre-processed as discussed below to create the linked video files as discussed above. The pre-processing discussed below is merely exemplary. Other types of pre-processing may also be suitable.

In an exemplary embodiment in a development mode of operation, the video content may be preprocessed by an image processing system for automatically tracking a pixel object, selected in a frame of a video frame sequence, in preceding and succeeding video frames for the purpose of linking the selected object to one or more data objects. The image processing system compensates for changes in brightness and shifts in hue on a frame by frame basis due to lighting effects and decompression effects by determining range limits for various color variable values, such as hue (H), red-green (R-G), green-blue (G-B) and saturation value² (SV²) to provide relatively accurate tracking of a pixel object. Moreover, unlike some known image processing systems, the exemplary image processing system does not embed tags in the video content. Rather the exemplary system, generates linked video files, which identify the pixel coordinates of the selected pixel object in each video frame as well as data object links associated with each pixel object. The linked video files are exported to the viewer interaction platform 13 which includes the viewer frame interaction application which supports playback of content of various compression schemes such as those used by various commonly known media players, such as Real Player, Windows Media Player and Quick Time and enables pixel objects to be selected during playback with a pointing device, such as a mouse which enables access to linked to data objects.

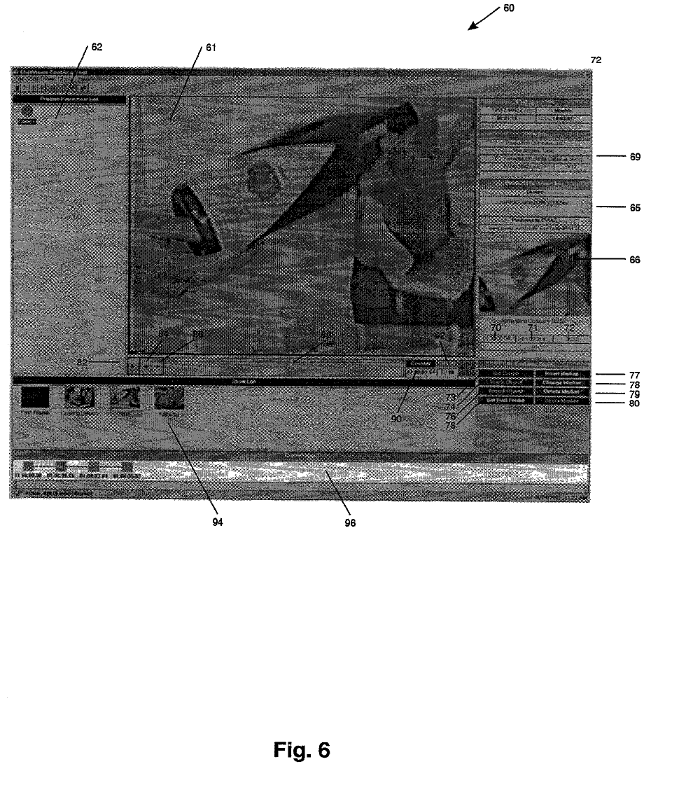

A graphical user interface (GUI) may be provided to facilitate the development of linked video files during a development mode of operation. In particular, a developmental GUI, for example, as illustrated in FIG. 6, may be used to facilitate processing of the original video content by either a video content provider or an application service provider, to develop the linked video files as discussed above.

Various embodiments of the exemplary video content pre-processing are contemplated. For example, referring to FIG. 5, the system may be implemented by way of a resource platform, shown within the dashed box 20, formed from one or more servers or work stations, which may constitute an Application Service Provider or may be part of the video content producer. In this implementation, a source of video content 22, for example, an on-demand source from, for example, a DVD player or streaming video source from a video content producer, is transferred to the resource platform 20, which, in turn, processes the video content 22 and links selected pixel objects within the video content 22 to data objects and generates linked video files 24.

The resource platform 20 is used to support a development mode of operation in which the linked video files 24 are created from the original video content 22. As shown in FIG. 5, the resource platform 20 may include an exemplary resource computing platform 26 and a video processing support computing platform 28. The resource computing platform 26 includes a pixel object capture application 30, a video linking application 32 and generates the linked video files 24 as discussed above. The pixel object capture application 30 is used to capture a pixel object selected in a frame of video content 22. The video linking application 32 automatically tracks the selected pixel object in preceding and successive frames in the video sequence and links the pixel objects to data objects by way of a pixel object file and data object file, collectively referred to as linked video files 24. The linked video files 24 are created separately from the original video content 22 and are amenable to being exported to the server 12 (FIGS. 1 and 5).

The resource computing platform 22 may be configured as a work station with dual 1.5 GHz processors, 512 megabits of DRAM, a 60 gigabit hard drive, a DVD-RAM drive, a display, for example, a 21-inch display; a 100 megabit Ethernet card, a hardware device for encoding video and various standard input devices, such as a tablet, mouse and keyboard. The resource computing platform 26 is, preferably provided with third party software to the hardware.

The video processing support computing platform 28 includes a show information database 34 and a product placement database 36. The show information database 34 includes identifying information relative to the video content, such as show name, episode number and the like. The product placement database 36 includes data relative to the various data objects, such as website addresses, to be linked to the selected pixel objects. The show information database 34 as well as the product placement database 36 may be hosted on the video processing support computing platform 28 or may be part of the resource computing platform 26.

Development Mode of Operation

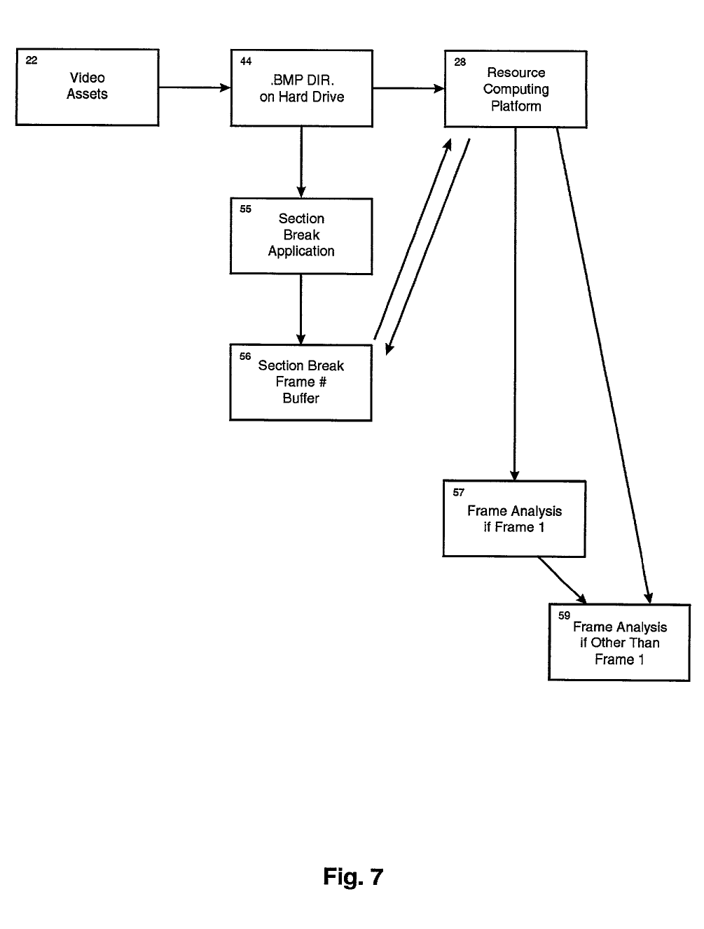

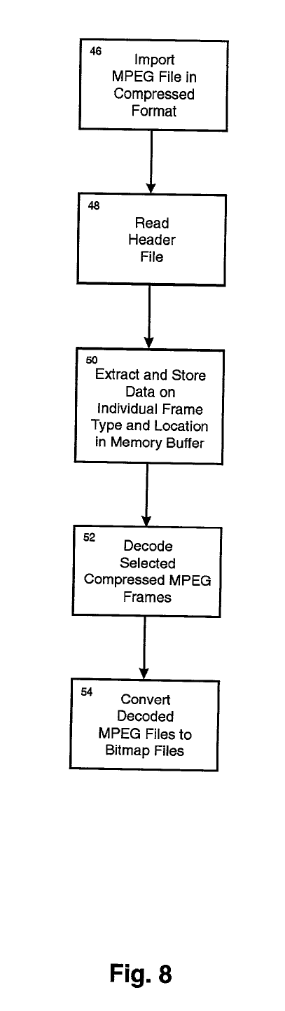

The development mode of operation is discussed with reference to FIGS. 7-11. Turning to FIG. 7, a video source, such as, a streaming video source, for example, from the Internet or an on-demand video source, such as a DVD player, is imported by the pixel object capture application 30 (FIG. 5) which captures, for example, 12 frames per second of the video content 20 and converts it to a bit map file 44. In particular, the video content 22, for example, in MPEG format, is decompressed using public domain decoder software, available from the MPEG website (www.mpeg.org) developed by the MPEG software simulation group, for example, MPEG 2 DEC, an executable MPEG 2 decoder application. As is known in the art, such MPEG decoder software decodes an entire MPEG file before providing global information on the file itself. Since the video content must be identified by frame for use by the pixel object capture application 30 and the video linking application 32, the frame information may be read from the decoded MPEG file once all of the frames have been decoded or alternatively determined by a frame extraction application which stores the frame information in a memory buffer as the MPEG file is being loaded into the pixel capture application 30 as illustrated in FIG. 8 and described below.

Frame Extraction Application

The frame extraction application is illustrated in FIG. 8 and described below. Referring to FIG. 8, the MPEG file is imported into the pixel object capture application 30 in compressed format in step 46. In this embodiment, the pixel object capture application 30 works in conjunction with the standard MPEG decoder software as illustrated in FIG. 8 to avoid waiting until the entire file is decoded before obtaining the frame information. While the MPEG file is being imported, the pixel object capture application 30 reads the header files of the MPEG data in step 48 and stores data relating to the individual frame type and location in a memory buffer in step 50. As such, the pixel object capture system 30 is able to decode selected frames of the compressed MPEG file without the need for decoding all of the previous frames in step 52. Based upon the frame information stored in the memory buffer in step 50, the decoded MPEG files may then be converted to a bit map file 44 (FIG. 7), as discussed above in step 54.

Section Break Application

The pixel object capture application 30 may optionally be provided with a section break application 55 (FIG. 7) to facilitate downstream processing and aid partitioning of the content among several users. The section break application 55 analyzes the video content during loading. The section break data is stored in a temporary buffer 56 (FIG. 7) and used for pixel object analysis of a selected frame and proceeding and succeeding frames by the pixel object capture application 30 and the video linking application 32.

The section break application 55 automatically analyzes the video content to determine how changes in lighting affect RGB values creating large shifts in these values. In particular, the median average of the pixel values for a series of frames is computed. The section break application 55 compares the changes in the pixel values with the median average. A section break may be determined to be an approximately 5×change in pixel values from the median average. These section breaks are stored in a buffer 56 as a series of sequential frame numbers representing (start frame, end frame) where each start frame equals the proceeding frame plus one frame until the end of the video. This information may be edited by way of the graphical user interface 60 (FIG. 6), discussed below. If changes are made to the frame numbers corresponding to the section breaks, the new information is sent to the section break memory buffer 56 (FIG. 7) where the original information is replaced.

As will be discussed in more detail below, the frames in the video content are analyzed for a selected pixel object during a session with the pixel object capture application 30 (FIG. 5). A pixel object may be selected in any frame of a video sequence 57 (FIG. 7). The video linking application 32 processes preceding and subsequent frames 59 by automatically tracking the selected pixel object and generating linked video files 24 for an entire segment as defined by the segment break application, or for a length of frames determined by the operator. The segment may be as small as a single frame or may include all the frames in the content.

Developmental Graphical User Interface

In order to facilitate development, a developmental graphical user interface 60 may be provided, as illustrated in FIG. 6. As shown, the developmental graphical user interface 60 includes a viewing window 61 for displaying a frame of video content and a number of exemplary data fields to associate information with the video content.

An exemplary product placement list display window 62 is used to provide a graphic list of all of the data objects associated with a particular video frame sequence. The product placement list display window 62 is populated by the product placement database 36 (FIG. 5). The list of data objects is propagated anytime the developmental graphical user interface 60 is created or an existing graphical user interface 60 is opened.

As shown in FIG. 6, available data objects are displayed in the product placement list display window 62 as text and/or icons. In order to facilitate linking of the data objects to various pixel objects within the video frame sequence, the data objects displayed in the product placement display window 62 may be displayed in different colors. For example, one color may be used for data objects which have been linked to pixel objects while a different color may be used for data objects which have not been assigned to pixel objects. Such technology is well within the ordinary skill in the art, for example, as disclosed in U.S. Pat. No. 5,983,244, hereby incorporated by reference.

A “Show Info” data field 64 may also be provided in the developmental graphical user interface 60. The show information data field 64 is populated by the show information database 34 and may include various data associated with the video frame sequence, such as production company name; show name; episode number/name; initial broadcast date; and proposed ratings.

A “Product Placement Info” data field 65 and an associated display 66 may also be provided. The display area 66 is a reduced size image of the image displayed in the display window 61. The Product Placement Info data field 65 include various information regarding the data objects stored in the product placement database 36 (FIG. 5) for a selected data object. For example, these product placement information data object fields may include the following fields: product name; placement description; action, for example, redirect to another server; address of the alternate server; a product identifier; a locator descriptor as well as a plurality of data fields 70, 71 and 72 which indicate the frame locations of the data objects in the product placement list display 62 that have been linked to pixel objects. In particular, the data field 70 indicates the first frame in the video frame sequence in which the data object, identified in the Product Placement Info data field 65 is been linked to a pixel object. Similarly, the data field 71 identifies the last frame in the video frame sequence in which the data object has been linked to a pixel object. Lastly, the data field 72 identifies the total number of frames in the video frame sequence in which the selected data object has been linked to pixel objects.

In order to facilitate automatic authoring of the video frame sequence, the developmental graphical user interface 60 may be provided with a number of control buttons 73-80. These control buttons 73-80 are selected by a pointing device, such as a mouse, and are collectively referred to as “Enabling Tools.” A “Set Scope” control button 73, when selected, allows a user to select a pixel object in the display window 61 by way of a point device. An x, y display 92 identifies the x and y coordinates within the display window 61 corresponding to a mouse click by the user in connection with the selection of the pixel object within the display window 61.

A “Set First Frame” control button 76 allows the first frame of the video frame sequence to be selected by the user. Once the “Set First Frame” button 76 is selected, a number of control buttons 82, 84 and 86 as well as a scroll bar 88 may be used to advance or back up the frame being displayed in the display window 61. A counter display 90 is provided which identifies the selected frame.

Once the first frame is selected by the user, as discussed above, a “Bound Object” button 75 may be selected. The Bound Object button 75 causes the system to automatically draw a boundary around the selected pixel object based upon image processing edge boundary techniques as discussed below. The boundary may take the shape of a geometric object, such as a square, rectangle or circle as discussed in more detail below in connection with the pixel object capture application 30. After initial object has been captured, the Track Object button 74 may be selected for initiating automatic tracking or authoring of the selected pixel object in both proceeding and succeeding frames. As will be discussed in more detail below, the pixel object locations video frames and are used to create the linked video files 24.

In order to facilitate development of the linked video file 24, markers may be used under the control of the control buttons 77-80. The markers are used to identify the first frame associated with a marker. For example, a marker display window 94 is provided. The “Insert Marker” button 77 is selected to mark the first frame linked to a specific pixel object. The markers may be displayed in text and include a reduced size version of the marked frame.

The markers can be changed and deleted. The “Change Marker” button 78 allows a marker to be changed. In particular, by selecting the “Change Marker” button 78, the frame associated with that marker can be changed. This may be done by advancing or backing up the video frame sequence until the desired frame is displayed in the display window 61. The current marker and the marker display window 94 may then be changed to refer to a different frame number by simply selecting the “Change Marker” button 78.

A “Delete Marker” button 79 allows markers in the marker display window 94 to be deleted. In order to delete a marker, the marker is simply highlighted in the marker display window 94 and the “Delete Marker” button 79 is selected.

A “Show Marker” button 80 may also be provided. The “Show Marker” button 80 controls the display of markers in the marker display window 94. The “Show Marker” button 80 may be provided with a toggle-type function in which a single click shows the markers in the marker display window 94 and a subsequent click clears the marker display window 94.

Each of the markers are displayed in a content map display window 96. The content map display window 96 displays a linear representation of the entire content with all markers depicted along with the frame numbers where the markers appear.

Pixel Object Capture Application

The pixel object capture application 30 (FIG. 5) is initiated after the first frame is selected by the user by way of the development graphical user interface 60 (FIG. 6). In particular, After the section breaks are determined, the estimated first frame of the content is displayed in a viewing window 61 on the graphical user interface 60. Once this frame is loaded in the viewing window 61, the user may choose to specify another frame to be notated as the first frame. This is done to ensure that any extra frames captured with the content that do not actually belong to the beginning of the content can be skipped. The user may select a specific frame as the first frame as discussed above. The selected video frame is then loaded into the viewing window 61 for frame analysis as discussed below. The process of choosing the first frame is only performed once at the beginning of the program content, it is not necessary to do this at the start of each section.

When the viewing window 61 is loaded with content, the resource computing platform 26 accesses the show information database 34 and the product placement database 36 (FIG. 5) to populate the various data fields in the developmental graphical user interface 60 (FIG. 6) as discussed above.

Once a frame has been loaded into the viewing window 61 (FIG. 6) in the developmental graphical user interface 60, pixel objects are selected and captured during a session with the pixel object capture application 30 (FIG. 5). The video linking application 32 automatically tracks the selected pixel objects in the preceding and succeeding frames and generates linked video files 24, which link the selected pixel objects with data objects, stored in the product placement data base 38.

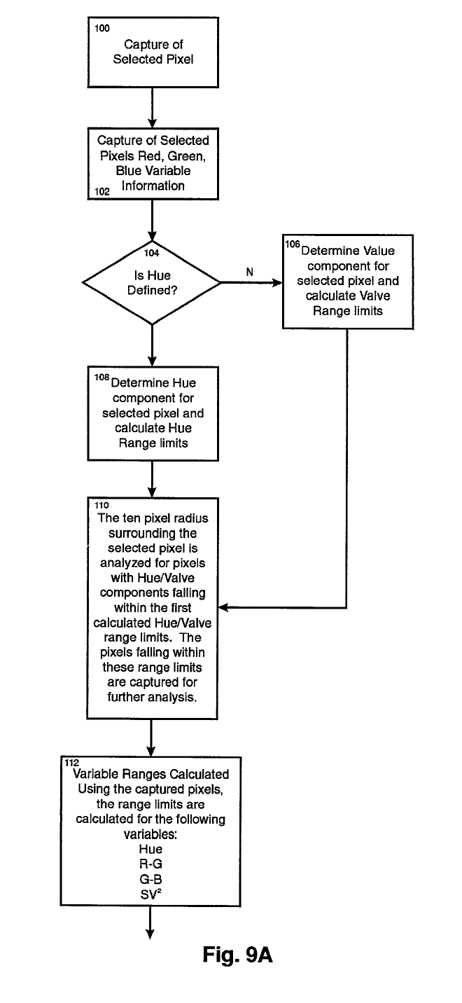

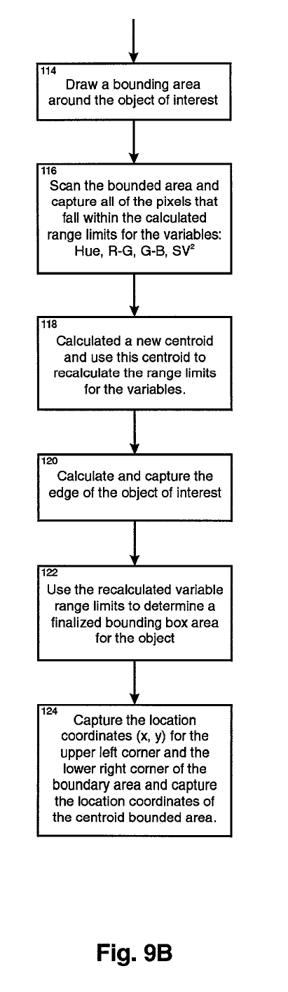

Selection and capturing of a pixel object is illustrated in connection with FIG. 6. In general, a pixel object is visually located in the viewing window 61 (FIG. 2) during a session with the pixel object capture application 30 by selecting a pixel in a single frame corresponding to the desired pixel object by way of a pointing device coupled to the resource computing platform 26 (FIG. 5) and processed as illustrated in FIGS. 9A and 9B. The selected pixel is captured in step 100. The captured pixel is analyzed in step 102 for either RGB (red, green, blue) values or Hue. In step 104, the system determines whether the hue value is defined. If so, range limits for the hue value are determined in step 106. Alternatively, the RGB color variable value component for the selected pixel may be calculated along with its range limits in step 108. The initial determination of the range limits for the hue or RGB color variables is determined by, for example, ±10 of the Hue or RGB color variable value. After the range limits for either the hue or the RGB color variables have been determined, the system analyzes the pixels in a 10-pixel radius surrounding the selected pixel for pixels with hue/value components falling within the first calculated range limits in step 110. The pixels that fall within these range limits are captured for further analysis. Range values for the pixels captured in step 110 are calculated in step 112. For example, range limits for the color variables: hue (H), red-green (R-G), green-blue (G-B) and the saturation value² (SV²) are determined for each of the variables. The range limits are determined by first determining the mean of the color variable from the sample and then for each variable, calculating the range limits to be, for example, 3× the sigma deviation from the mean to set the high and low range limit for each variable. Once the range limit for the variables are determined, known image processing techniques, for example, edge processing techniques, for example, as disclosed on pages 1355-1357 of Hu et al., “Feature Extraction and Matching as Signal Detection” International Journal of Pattern Recognition and Artificial Intelligence, Vol. 8, No. 6, 1994, pages 1343-1379, hereby incorporated by reference, may be used to determine the boundaries of the color within a frame as indicated in step 114. All of the pixels within the bounding area are captured that fall within the range limits for the variables, hue, R-G, G-V, SV² in step 116. Next, in step 118, a centroid is calculated for the bounding area and the range limits for the color variables are recalculated in step 118. The recalculated range limits determined in step 118 are used for determination of the edges of the bounding area in step 120 to define a finalized bounding area in step 122 for the object. In step 124, the location of the bounding area of the selected object is determined by capturing the (x, y) coordinates for the upper left corner and the lower right corner as well as the coordinates of the centroid of the bounded area. Thus far, selection of an object in a single frame of the video content has been discussed.

Automatic Pixel Object Tracking

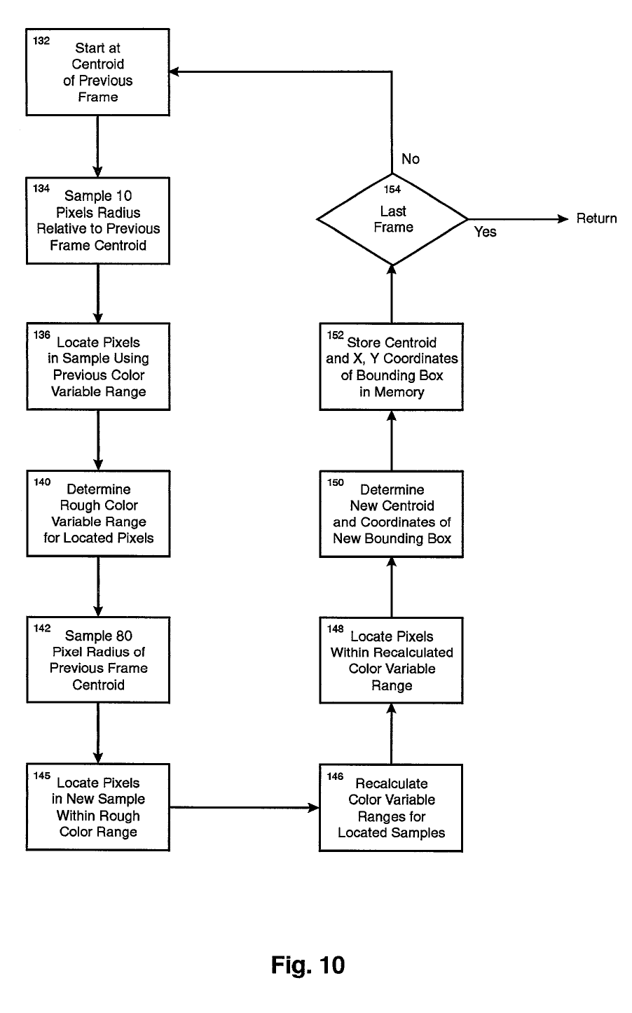

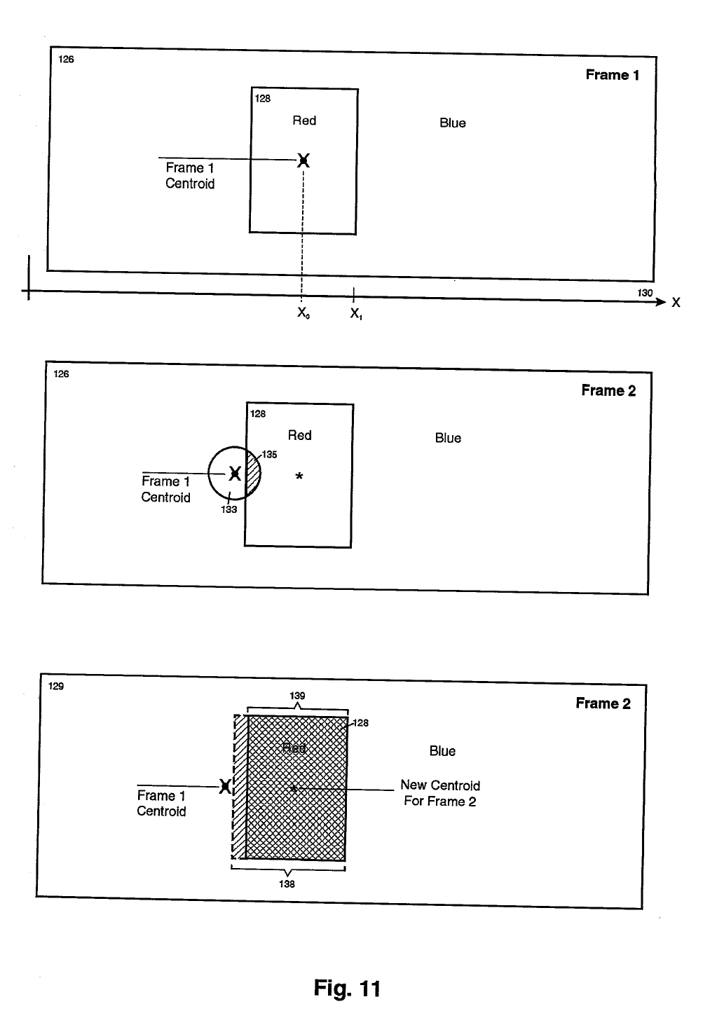

Automatic tracking of the selected pixel object is described in connection with FIGS. 10 and 11. In particular, FIG. 10 represents a flow chart for the automatic tracking system while FIG. 11 represents a visual illustration of the operation of the automatic tracking system. Referring first to FIG. 11, an exemplary frame 126 is illustrated, which, for simplicity, illustrates a red object 128 against a blue background. As shown, the pixel object 128 has a centroid at point X₀ along the X₁ axis 130. As shown in frame 2 identified with the reference numeral 129, the example assumes that the pixel object 128 has moved along the x-axis 130 such that its centroid is located at position x1 along the x-axis 130.

Referring to FIG. 10, the video linking application 36 (FIG. 5) begins automatic tracking by starting at the centroid of the previous frame in step 132. Thus, the video linking application 36 samples a 10-pixel radius 133 relative to the previous frame centroid in step 134 as illustrated in FIG. 11. Using the range limits for the color variables previously determined, the video linking application 36 locates pixels in the sample within the previous color variable range in step 136. As shown in FIG. 11, this relates to the cross-hatched portion 138 in frame 126. In order to compensate for variances in the color variables due to lighting effects and decompression effects, the video linking application 36 next determines a rough color variable range for the pixels within the cross-hatched area 135 in step 140 using the techniques discussed above. After the rough color variable range is calculated, the video linking application 36 samples a larger radius, for example, an 80 pixel radius, based on the previous frame centroid in step 142. As shown in FIG. 11, this example assumes that a substantial portion of the pixel object 128 is within the second sample range. In step 145, the pixels in the new sample which fall within the rough color variable range are located and are indicated by the cross-hatched area 138 in FIG. 11. In order to further compensate for variances in the color variables, the video linking application 36 recalculates the color variable ranges for the located samples in step 146. Once the refined color variable range has been determined, the pixels within the recalculated color variable range are located in step 148. As shown by the double cross-hatched area 139 in FIG. 11, the pixels within the recalculated color variable range are illustrated in FIG. 11. As can be seen from FIG. 11, the pixels falling within the rough color range, in the example, are shown to cover a larger area than the pixel object 11. Once the color range values are recalculated in step 146 in the pixels within the recalculated color variable range are determined in step 148 the pixel object 128 is located and in essence filters out pixels falling outside of the pixel object 128 as shown in FIG. 8. Once the pixels are located with the recalculated color variable range in step 148, a new centroid is determined in step 150. In addition to calculating the centroid, the video linking application 36 also determines the coordinates of the new bounding box, for example, as discussed above in connection with steps 120-124. In step 152, the system stores the coordinates of the centroid in the (x, y) coordinates of the bounding box in memory. The system checks in step 154 to determine if the last frame has been processed. If not, the system loops back to step 132 and processes the next frame by repeating steps 134 to 154. As mentioned above, the frame data is extracted from the video content and utilized to define the frames within a segment. Thus, this process may be repeated for all the frames identified in the first frame found and last frame found fields in the developmental graphical user interface 60. Alternatively, the video linking application can be configured to process more frames than those found within segment. However, by breaking down the processing in terms of segments, tracking of the pixel objects will be relatively more accurate because of the differences in the color variable values expected during segment changes.

Linked Video Files

In order to further optimize the image processing of the video linking application 32, the resource computing platform 26 may process all or part of the video frames and store the coordinates in step 152 (FIG. 10), Assuming the fastest possible human reaction time to be ⅓ of a second, it follows that an extraction rate of 10 frames per second will provide adequate tracking information Thus, the linked video files 24 store the centroid coordinates of the upper left and lower right coordinates of the selected objects within the ⅓ second intervals known as clusters. At 30 FPS, a cluster is defined as a ten frame segment of video. The file information illustrating object movement contained within the ten frame segment is represented by the coordinates used (upper left, and lower right corners) to draw the object bounding boxes. Thus, ten frames of information are compressed into one. The number of frames per cluster depends on the frame rate. Using standard frame rate clusters are defined as follows:

| Standard (FPS = frames/second) | Frames/Cluster |
|---|---|
| NTSC (29.97 FPS) | 10 |
| 30 FPS | 10 |
| PAL (25 FPS) | 8, 8, 9/video section |
| 15 FPS | 5 |
| 12 FPS | 4 |

Since the linked video files 24 are based on a sample rate of three (3) frames per second, the linked video files 21 will be usable at any playback rate of the original content. Moreover, by limiting the sample rate to three (3) frames per second, the linked video files 21 are suitable for narrowband transmission, for example, with a 56 K bit modem as well as broadband streaming applications, such as ISDN, DSL, cable and T1 applications.

Exemplary linked video files 24 are described and illustrated below.

Exemplary Linked Video File

| | | | | | |
|---|---|---|---|---|---|
| Line 1: | 569 | 0 | 2172 | 30 | 0 |
| Line 2: | 129 | 0 | 0 | 0 | 0 |
| Line 3: | 001 | 001 | 010 | 4 | 132 |
| | 002 | 011 | 025 | 4 | 137 |
| | 003 | 026 | 040 | 4 | 142 |
| | 004 | 041 | 055 | 4 | 147 |
| | 005 | 056 | 070 | 4 | 152 |
| | . . . | | | | |
| | 128 | 2136 | 2150 | 2 | 564 |
| Line 131: | 129 | 2151 | 2172 | 2 | 567 |
| Line 132: | 001 | 001 | 010 | 4 | 132 |
| | 6 | 125 | 276 | 199 | 1 |
| | 138 | 75 | 179 | 119 | 2 |
| | 213 | 60 | 246 | 83 | 3 |
| | 207 | 92 | 241 | 117 | 4 |
| Line 137: | 002 | 011 | 025 | 4 | 137 |
| | 9 | 123 | 278 | 199 | 1 |
| | 133 | 52 | 177 | 119 | 2 |
| | 212 | 56 | 250 | 83 | 3 |
| | 208 | 89 | 243 | 118 | 4 |
| Line 142: | 003 | 026 | 040 | 4 | 142 |
| Line 1: | 569 | 0 | 2172 | 30 | 0 |

Line 1

The first number in Line 1 (569) identifies the total number of lines in the linked video file 24 file. The next two numbers in Line 1 (0, 2172) are the first and last frame numbers for the movie clip associated with the linked video file 24. The next number in Line 1(30) indicates the playing of the movie clip in frames-per-second.

Line 2

| | | | | | |
|---|---|---|---|---|---|
| Line 2: | 129 | 0 | 0 | 0 | 0 |

Line 2 only uses the first space, and the number in this space indicates the total numbers of video frame “clusters” in the video content.

Line 3

| | | | | | |
|---|---|---|---|---|---|
| Line 3: | 001 | 001 | 010 | 4 | 132 |

In this example, Lines 3-131 contain information on the one hundred twenty-nine (129) video cluster. Each such line follows a similar format. The first number, 001 in this example, is the cluster number. The next two numbers (001,010) are the starting and ending frames of the video segment. The next number (4) indicates that this video cluster has four clickable areas or objects within it. The final number (132) indicates the line of the linked video file 24 where a detailed description of the video cluster can be found.

Line 132

| | | | | | |
|---|---|---|---|---|---|
| Line 132: | 001 | 001 | 010 | 4 | 132 |
| Line 133: | 6 | 125 | 276 | 199 | 1 |
| | 138 | 75 | 179 | 119 | 2 |
| | 213 | 60 | 246 | 83 | 3 |
| | 207 | 92 | 241 | 117 | 4 |

In this example, the detailed descriptions of the video clusters begins on line 132 for video cluster #1. The first line repeats the general video cluster information from prior in the linked video file 24. Each of the following four lines provide information on a separate clickable area. The first four numbers are the (x,y) coordinates for the upper left corner and the lower right corner, respectively. In Line 133, for instance, (6, 125) are the (x,y) coordinates for the upper left corner and (276, 199) are the (x,y) coordinates for the lower right corner of that video cluster. The last number in the line (“1” in Line 133) is the “link index”. The “link index” links the pixel object coordinates with the data object coordinates from the product placement database 36 (FIG. 1).

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

Exemplary Code for Reading Data into First Array

numberOfLine = readFirstNumberOfFirstLine( );
startFrame = readNextNumber ( );
endFrame = readNextNumber ( );
trueFramePerSecond = readNextNumber ( );
numberOfMovieSegment = readFirstNumberOfSecondLine ( );
for (int i=0; i<numberOfMovieSegments; i++) {

firstArray [i*5] = readNextNumber ( );
firstArray [i*5+1] = readNextNumber ( );
firstArray [i*5+2] = readNextNumber ( );
firstArray [i*5+3] = readNextNumber ( );
firstArray [i*5+4] = readNextNumber ( );
numberOfClickableAreas =

calculateTheSumOfClickableAreas
(firstArray [i*5+3]);

}

Exemplary Code for Reading Data into Second Array

for (int i=0; i<numberOfClickableAreas; i++) {

readLine ( );
secondArray [i*5] = readNextNumber ( );
secondArray [i*5+1] = readNextNumber ( );
secondArray [i*5+2] = readNextNumber ( );
secondArray [i*5+3] = readNextNumber ( );
secondArray [i*5+4] = readNextNumber ( );

}

Exemplary Code for Returning a Link Index

int getLinkIndex(int x, int y, in frameNumber) {

approximatedFrameNumber = frameNumber *
trueFramePerSecond / 12;
segmentNumber = getSegmentNumber (approximateFrameNumber);
numberOfClickableAreas = firstArray[segmentNumber*5 + 3];
segmentStart = firstArray[segmentNumber*5 + 4]

- numberOfSegments — 3;
// 3 is the offset needed due to extra lines

for (int i=0; i < numberOfClickableAreas; i++) {

x0 = secondArray[ (segmentStart + i)*5];
y0 = secondArray[ (segmentStart + i)*5 + 1];
x2 = secondArray[ (segmentStart + i)*5 + 2];
xy2 = secondArray[ (segmentStart + i)*5 + 3];
if(x0 <= x && x <= x2 && y0 <= y && y <= y2) {

return secondArray [(segmentStart + i)*5 + 4];
}

}
return −1;

}

We claim:

1. A real time interactive video system comprising:
a server for storing a sequence of frames of video content in a frame buffer;
a viewer interaction platform which includes a system for identifying frames of said sequence of frames of video content selected by a user by way of timing signals defining a timed request and exporting said timed requests to said server, said server including a system for comparing said timed requests with said stored video frames and exporting said video data to said viewer interaction application on said device which corresponds to said timed requests for interaction with pixel objects in said video content; and
a timing device for providing said timing signals to said server, said timed signals being synchronized to a real time broadcast of said video content.

2. The real time interaction system as recited in claim 1, wherein said timing signals are time stamps.

3. The real time interaction system as recited in claim 1, wherein said video frames are stored sequentially in said video buffer.

4. The real time interaction system as recited in claim 1, wherein said timing signals are time code numbers.

5. The real time interaction system as recited in claim 4, wherein said video frames are stored by time code number.

6. The real time interaction system as recited in claim 1, wherein said video content does not include embedded tags.

7. The real time interaction system as recited in claim 6, further including a system for reading linked video files which link predetermined pixel objects in said video frames with predetermined data objects.

8. The real time interaction system as recited in claim 7, wherein said linked video files are exported to said viewer interaction platform.

9. The real time interaction system as recited in claim 1, wherein said viewer interaction platform includes a local storage device for storing user selected video frames.

10. The real time interaction system as recited in claim 1, wherein said viewer interaction platform includes viewer frame interaction application that is configured to support playback of said video frames.

11. The real time interaction system as recited in claim 10, wherein said viewer frame interaction application is configured to support one or more local frame advance navigational buttons.

12. The real time interaction system as recited in claim 1, wherein said frame interaction application is configured to support, a frame advance dialog box which allows unselected frames on the server to be called on a time interval basis.

13. The real time interaction system as recited in claim 10, wherein said viewer frame interaction application is configured to support a drop down menu for selecting time intervals.

14. The real time interaction system as recited in claim 10, wherein said viewer interaction application is configured to support one or more server frame advance navigational buttons for viewing unselected frames in said server.

15. The real time interaction system as recited in claim 1, wherein said viewer interaction application supports a graphical user interface.
